(19) United States
(12) Patent Application Publication
(10) Pub. No.: US 2015/0278341 A1
(43) Pub. Date: Oct. 1, 2015

(54) DATA SEARCH PROCESSING

(71) Applicant: Alibaba Group Holding Limited, Grand Cayman (KY)

(72) Inventor: Jingjing Shen, Hangzhou (CN)

(21) Appl. No.: 14/665,997

(22) Filed: Mar. 23, 2015

(30) Foreign Application Priority Data
Mar. 28, 2014 (CN) 201410123992.7

(51) Int. Cl. G06F 17/30; G06Q 30/02

(52) U.S. Cl. CPC G06F 17/30598; G06F 17/3053; G06F 17/30997; G06Q 30/0277; G06F 17/30867

(57) ABSTRACT

First ranking scores of different search objects in a search result are obtained based on a first ranking model. The first ranking scores are divided into multiple intervals. The search objects are classified into different sets of search objects corresponding to the multiple intervals. One or more search objects with one or more preset labels within a set of data objects corresponding to each interval are determined. Second ranking scores of the search objects with the preset labels are obtained based on a second ranking model. The second ranking scores are used to adjust rankings of the search objects with the preset labels within the sets of search objects of the corresponding intervals. Based on the condition of ensuring correlation of the search result, the present techniques improve consistency and continuity of the displayed search result, provide uniform user experience, and simplify algorithms to reduce data processing complexity and to improve efficiency and system processing performance.

### CROSS-REFERENCE TO RELATED PATENT APPLICATIONS

This application claims foreign priority to Chinese Patent Application No. 201410123992.7 filed on Mar. 28, 2014 entitled “Data Search Processing Method and System,” which is hereby incorporated by reference in its entirety.

### TECHNICAL FIELD

The present disclosure generally relates to the field of data search, and, more particularly, to a data search processing method and system.

### BACKGROUND

With the development of Internet technology, more and more users visit a network to conduct data search and obtain returned search results. Data search processing technology at a server that performs a search and provides a search result according to a search request achieves an important function of implementing a searching purpose of the user. For example, the data search processing technology includes processing the search result to best meet a user requirement, processing the search result to improve a processor performance, optimizing data management efficiency, etc. The conventional search processing technology, according to the search request of the user, conducts a search via a search engine or a correlation engine respectively. In other words, the search engine finds a data object and the correlation engine finds extension information based on the data object. Then the data object and the extension information based on the data object are processed and adjusted for outputting together. For example, the extension information based on the data object is embedded into the found data object and displayed to the user that inputs a query word together with the data object.

A common application of the search technology is a product search engine. A paid advertisement is embedded into the search result. Specifically, as shown in FIG. 1A, (1) a user visits a product search website via a browser, inputs a product inquiry term, and clicks a search button to request a search. (2) The browser visits an application server of the website. (3) The application server requests an advertisement result with respect to the search (advertisement result based on the product) from an advertising engine and a product search result with respect to the search from a search engine. (i) The advertising engine returns the advertisement result according to certain logic. For example, the product inquiry term is matched with a keyword purchased by an advertiser to obtain advertised products that meet conditions. The obtained advertised products are ranked according to expected maximum returns for advertisements (such as advertisement bid, matching degree, and advertisement creativity quality) and top m advertised products are returned as the result. (m is an integer.) (ii) The search engine returns the search result according to certain logic. For example, the inquiry term is matched with text descriptions of products to obtain products that meet the conditions. Matching degrees between the products and the requirement of the user who submits the search request according to dimensions such as correlation, product quality are calculated to determine the rankings of the output products. Top n products are returned as the result. (n is an integer.) (4) The application server obtains the advertisement result and the search result of the products and conducts calculation. For example, products already included in the advertisement result (advertised products) are filtered from the search result of the products. The calculated results are merged and adjusted for rankings. A page is rendered and returned to the browser to display to the user that submits the search request.

As shown from FIG. 1A, a search result is returned for output. As an example of “product transaction platform search,” paid advertisements are displayed along with searched products, such as at a top, bottom, or right side bar, as a part of the search result, as shown in the ride side bar of FIG. 2. Advertisements are displayed independently. A browser directly visits an advertising engine to obtain the advertisement result and displays it at a corresponding advertisement location to shorten page processing time. In addition, the search result may be output as shown in FIG. 1B. As a “bid ranking” shown in FIG. 3, the paid advertisements are embedded into the search result. When the search result is output to a webpage, the paid advertisements are shown within a square frame. The search result and the advertisement result are mixed. After the obtained search result and advertisement result are combined together (such as by a combined ranking server), the application server sends the combined ranking result to the browser.

The two display methods after the two search processing are to display the result from the search engine and the result form the advertising engine at one page. However, the two methods have shortcomings.

First, as the final displayed result is a combination of the results from two engines, while the two engines correspond to different sets of products and different ranking algorithms, the final displayed result shows inconsistent and irrelevant effects, thereby causing inconsistent user experiences, especially when the advertisement result and the search result are mixed or combined together. As the two engines use inconsistent ranking logics, the final displayed result has bad effect, lacks consistency and relevancy, and further causes inconsistent user experiences.

For example, a set of total products is A, B, C, D, E, and F. A set of products that participate in advertisements is C, D, and E. A set of products for the search engine is the total set of products A, B, C, D, E, and F. A set of products for the advertising engine is C to E. A possibility of a user's initiated search may be that the search engine returns a result of A, C, and E, the advertising engine returns a result of C, and E, and a combined result displayed to a user is A, C, E, and F. As A, C, and F are displayed according to a rule of the search engine, an insertion of E confuses a judgment of the user. From a perspective of advertisement ranking, even though text description of E is not closely related with a user inquiry, if a bid for E is high, E is still returned to the user. Thus, a comprehensive result of the user's experience is weakly correlated and inconsistent.

Second, under the conventional technology, the application server needs to request two search engines. The goals of the two engines are different and their ranking conditions are different. The final displayed result needs to combine the results of the two engines and remove redundancy. Thus, the final rankings of the same objects are inconsistent, operations such as combining results and removing redundancy are increased, a complexity degree of a computing system is increased, and a processing efficiency of the computing system is low.

Therefore, the conventional technologies for data search processing needs to be improved to increase efficiency and provide uniform and satisfying user experience.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present disclosure provides an example data searching processing method. First ranking scores of different search objects in a search result are obtained based on a first ranking model. The first ranking scores are divided into multiple intervals. The search objects are classified into different sets of search objects corresponding to the multiple intervals. One or more search objects with one or more preset labels within a set of data objects corresponding to each interval are determined. Second ranking scores of the search objects with the preset labels are obtained based on a second ranking model. The second ranking scores are used to adjust rankings of the search objects with the preset labels within the sets of search objects of the corresponding intervals.

For example, the first ranking scores of the different search objects in the search result obtained based on the first ranking model are as follows. The search result is obtained based on a keyword input by a user. Correlations between each search object and the keyword within the search result are calculated based on the first ranking model and the obtained correlation values are used as the first ranking scores.

For example, the first ranking scores are divided into multiple intervals and the search objects are classified into different sets of search objects corresponding to the multiple intervals as follows. One or more correlation threshold values are set. The first ranking scores are divided into the multiple intervals according to the correlation threshold values. According to an interval to which a respective first ranking score belongs, a respective search object with the respective first ranking score is classified into a set of search objects corresponding to the interval.

For example, the search objects with the preset labels may include the following. Based on extension information of the search objects and the record related to the extension information, the preset labels indicate that the respective search objects include the extension information. For example, the second ranking scores are used to adjust rankings of the search objects with the preset labels within the sets of search objects of the corresponding intervals as follows. The search result within which the rankings are adjusted is returned to the user and the extension information of the respective search object with the preset labels is also returned to the user.

For example, the second ranking scores of the search objects with the preset labels may include the following. The second ranking model uses the record to calculate a respective second ranking score of a respective data object with the preset labels. For example, the second ranking scores are used to adjust rankings of the search objects with the preset labels within the sets of search objects of the corresponding intervals as follows. Within each set of search objects corresponding to each interval, new rankings of the second ranking scores of the search objects with the preset labels are determined according to their second ranking scores and rankings of all search objects within the set of search objects are adjusted.

The present disclosure provides an example data searching processing system. The system may include the following modules. A first ranking score module obtains first ranking scores of different search object in a search result based on a first ranking model. A classifying module divides the first ranking scores into multiple intervals and classifies the search objects into different sets of search objects corresponding to the multiple intervals. A determining module determines one or more search objects with one or more preset labels within a set of data objects corresponding to each interval. A second ranking score module obtains second ranking scores of the search objects with the preset labels based on a second ranking model. A ranking adjusting module uses the second ranking scores to adjust rankings of the search objects with the preset labels within the sets of search objects of the corresponding intervals.

For example, the first ranking scores module obtains the search result based on a keyword input by a user, calculates correlations between each search object and the keyword within the search result based on the first ranking model, and uses the obtained correlation values as the first ranking scores.

For example, the classifying module sets one or more correlation threshold values, divides the first ranking scores into the multiple intervals according to the correlation threshold values, and classifies, according to an interval to which a respective first ranking score belongs, a respective search object with the respective first ranking score into a set of search objects corresponding to the interval.

For example, the search objects with the preset labels may include the following. Based on extension information of the respective search object and a record related to the extension information, the preset labels indicate that the respective search object includes the extension information. For example, the ranking adjusting module returns the search result within which the rankings are adjusted to the user and also returns the extension information of the respective search object with the preset label to the user.

For example, the second ranking score module uses the second ranking model to use the record to calculate a respective second ranking score of a respective data object with the preset label. For example, the ranking adjusting module determines, within each set of search objects corresponding to each interval, new rankings of the second ranking scores of the search objects with the preset label according to their second ranking scores and adjusts rankings of all search objects within the set of search objects.

Compared with the conventional techniques, the present techniques conduct a search via a uniform search engine based on the extension information of the data objects, thereby avoiding inconsistent user experiences. In addition, to ensure the correlation of the result and a priority to display the data objects with the extension information, the present techniques divide the intervals to adjust rankings in a small scale. The present techniques may be easily implemented without using complex algorithms. Furthermore, the present techniques obtain the result of the data objects and the extension information based on the data objects via a direct search by the search engine and use a uniform ranking rule, thereby optimizing data processing and relevant data processing system, achieving uniform user experience, and effectively improving user experience.

### BRIEF DESCRIPTION OF THE DRAWINGS

The accompanying FIGs illustrate the present disclosure and become part of the present disclosure. The example embodiments of the present disclosure and their descriptions are used to illustrate the present disclosure, and shall not be construed to unduly limit the present disclosure.

FIGS. 1A and 1B are diagrams illustrating application of conventional data search processing techniques.

FIGS. 2 and 3 are diagrams illustrating example display results by the existing data search processing technology.

FIG. 4 is a flow chart illustrating an example data search processing method according to the present disclosure.

FIG. 5 is a diagram illustrating an example application of the example data search processing method.

FIG. 6 is a flowchart illustrating an example process for ranking search objects according to an example embodiment of the present disclosure.

FIG. 7 is a diagram illustrating an example application of a preset label in the example data search processing method.

FIG. 8 is a flow chart illustrating an example data search processing system according to the present disclosure.

### DETAILED DESCRIPTION

The present techniques match data objects with an inquiry term of a user in a searching process, obtain ranking scores according to correlations between the data objects and the inquiry term, set one or more correlation threshold values to classify the ranking scores into multiple intervals, and classify searched data objects (search objects) into sets of search objects of corresponding intervals. The present techniques then introduce various records related to extension information of the data objects as factors affecting rankings of the search objects, such as a bidding factor. The present techniques use the affecting factors to adjust rankings within the sets of search objects of a correlation threshold value internal corresponding to each search object. The present techniques combine two rankings within one search process, ensure correlations of the search result, and improve consistency and continuity of returned search result. In addition, the present techniques reduce complicated mixing and redundancy removing algorithms to lower data processing complexity, improve data processing efficiency, and increase data processing system performance. The present techniques simplify processing procedure to effectively increase system processing efficiency and calculating performance and to provide satisfactory consistent user experiences. The application of the present disclosure, such as a product search, inputs advertising ideas of an advertiser for a product into a search engine of the product. The search engine uniformly returns a search result and an advertising result in a searching environment. Thus the present techniques directly commercialize the search result, and improve allocation of an advertised product in the search result based on the precondition that the search result is correlated, thereby effectively commercializing the search engine.

To clearly illustrate the purpose, technical solutions, and advantages of the present disclosure, the example embodiments of the present disclosure and their corresponding FIGs are used to describe the present techniques. The example embodiments represent a portion of and do not represent all embodiments of the present disclosure. All of the other embodiments obtained by one of ordinary skill in the art without using creative efforts based on the example embodiments of the present disclosure fall under the protection of the present disclosure.

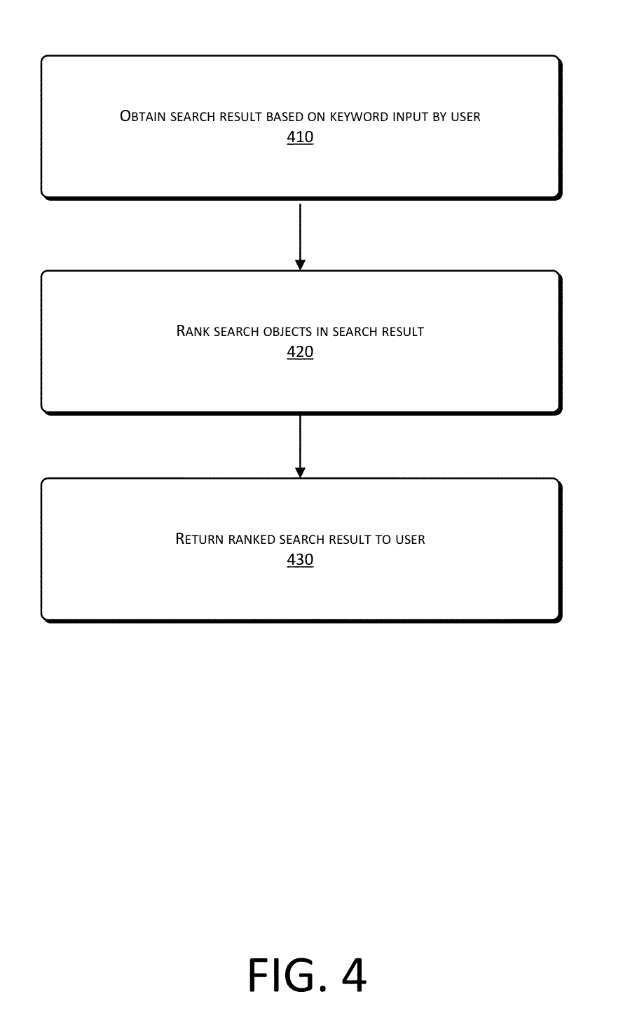

The present disclosure provides an example data search processing method. FIG. 4 illustrates a flowchart of the example data search processing method.

At 410, a search result is obtained based on a keyword input by a user.

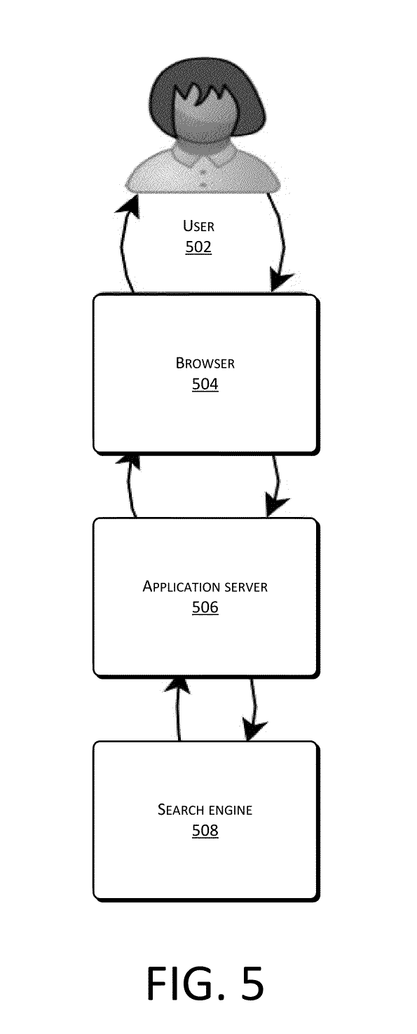

FIG. 5 shows a diagram of an example application of the example data searching process method. A user 502 visits a searching platform such as a product searching platform via a browser 504. The user 502 inputs a keyword at the browser 504 and sends a search request. For example, the user 502 inputs a product name and clicks a search button. The browser 504 visits an application server 506 of the search platform. The application server 506 receives the search request. The application server 506 requests a search engine 508 to perform a search with respect to the search request. The search engine 508 uses the keyword that is obtained after an inquiry term is pre-processed to perform the search to obtain a search result.

The search engine 508 matches the keyword with text descriptions of multiple data objects in a set of total data objects. For example, a searching model based on a similarity degree between the keyword and the text descriptions of the data objects is used to find text descriptions that have correlation degrees (correlation) with the keyword. Data objects corresponding to such text descriptions are data objects matching the keyword in the search result. The correlation is a searching correlation or indexing correlation.

For example, some data objects have extension information based on the data objects. With respect to the data objects with the extension information, a preset label is used to mark the data objects to be distinguished from data objects without extension information. In addition, the extension information of the data objects with the extension information may be stored. Furthermore, various records relating to the data objects with the extension information may be stored.

Using an example of product search, the user 502 inputs a keyword such as a product name via the browser 504 and clicks the search button. The browser 504 visits the application server 506 of the search platform and transmits the product name to the application server 506. The application server 506 requests the search sever 508 to perform the product search. For example, through a similarity degree calculation based on a searching model (such as an information retrieval (IR) model based on an algebraic theory, an IR model based on probabilities, an IR model based on set theory, a machine learning model based on statistics, etc.), text descriptions that match the keyword or the product name are searched and products (data objects) corresponding to such text descriptions are obtained. Some products are advertised products that correspond to advertisements (the extension information based on the data objects). The advertised products may be pre-labeled to be distinguished from the products that are not advertised.

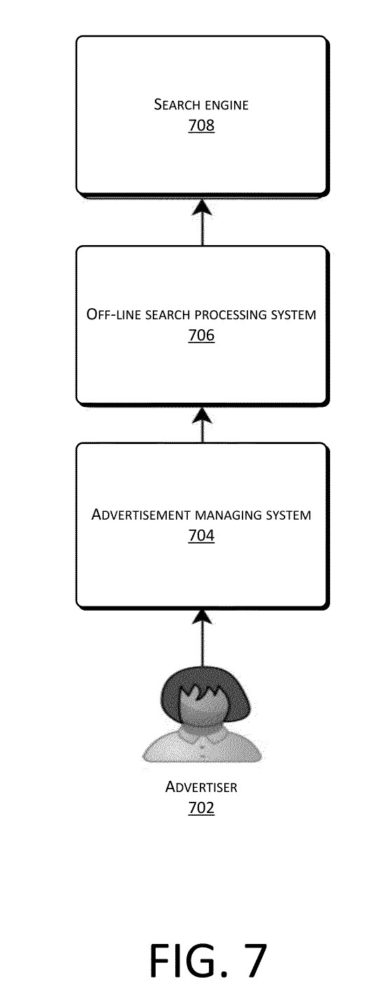

FIG. 7 illustrates a diagram of an example application of the preset label in the example embodiment of the data search processing method according to the present disclosure. An advertiser 702 uses an advertisement managing system 704 to manage advertised products. The advertiser 702 edits advertisement creation with respect to the products to be advertised (advertised products) and conducts a bid. The advertised products and their corresponding bids are entered into an off-line search processing system 706 to be combined with existing off-line processing data. For example, the advertised products with normal placement status in the set of searched products are labeled and their corresponding advertisement creation and biddings are recorded. The data objects combined by the off-line search processing system 706 are entered into the set of total products to be searched by a search engine 708. If the search engine 708 finds the advertised products, the advertised products have the preset label.

At 420, search objects in the obtained search result are ranked.

For example, the search engine ranks the search result according to a search ranking logic and retrieves search objects in the search result that match a preset correlation threshold value. With respect to search objects with the preset label in the search result, the search engine adjusts their rankings according to their records and returns the adjusted search result (to the application server, for example).

For example, a selection of the correlation threshold value is based on that it does not affect the search correlation. For instance, a linear combination of the correlation between the keyword used by the search engine for search and the text description of the data objects and other factors may be used to determine ranking values (scores) of the searched data objects (searched objects), i.e., ranking scores. For example, the ranking scores may be set between 1 and 100 with a score of 100 being the highest. A score of the linear combination is used to select the correlation threshold value. Thus, search objects whose scores are within a certain threshold are re-ranked according to factors such as whether the search objects have the preset label, thereby avoiding to affect original search experiences and considering actual requirements of search objects with the preset label.

For example, the product search engine ranks the search result and determines the rankings according to the linear combination of a correlation between the keyword used for the search and the text descriptions and various business numbers (such as a sale volume within last 30 days, a return rate, etc.). The correlation threshold value may be selected accordingly.

Using the previous product search example, the search engine uses one or more models such as a Boolean model, a vector space model, a probability model, a language model, or a machine learning model to calculate a similarity degree between the text description of the product and the inquiry term used by the user. That is, the correlation is determined according to the calculation of the correlation degree. Assuming that matched products A to I are obtained, the products A to I are ranked to obtain a sequence ABCDEFGHI. Each product has a ranking score. A correlation threshold value 20 is preset. Products whose ranking scores are higher than 20, such as the top 6 products with ranking scores e.g., A to F, are placed in an interval with high correlation. That is, the products that satisfy the correlation threshold value are ABCDEF. Products whose ranking scores are less than 20, e.g., G, H, I, are placed into an interval with low correlation. Furthermore, in the interval corresponding to scores higher than or equal to 20, with respect to advertised products which have a preset label and are normally displayed, e.g., C, E, F, in the search products A to F, a ranking sequence of C, E, F is adjusted to E, C, F according to their bidding records. The products whose sequences are adjusted are returned and output as EABCDF. Similarly, in the interval corresponding to scores less than 20, with respect to advertised products with the preset label and normally displayed, e.g., G, H, I, are re-ranked to IGH according to their bidding records.

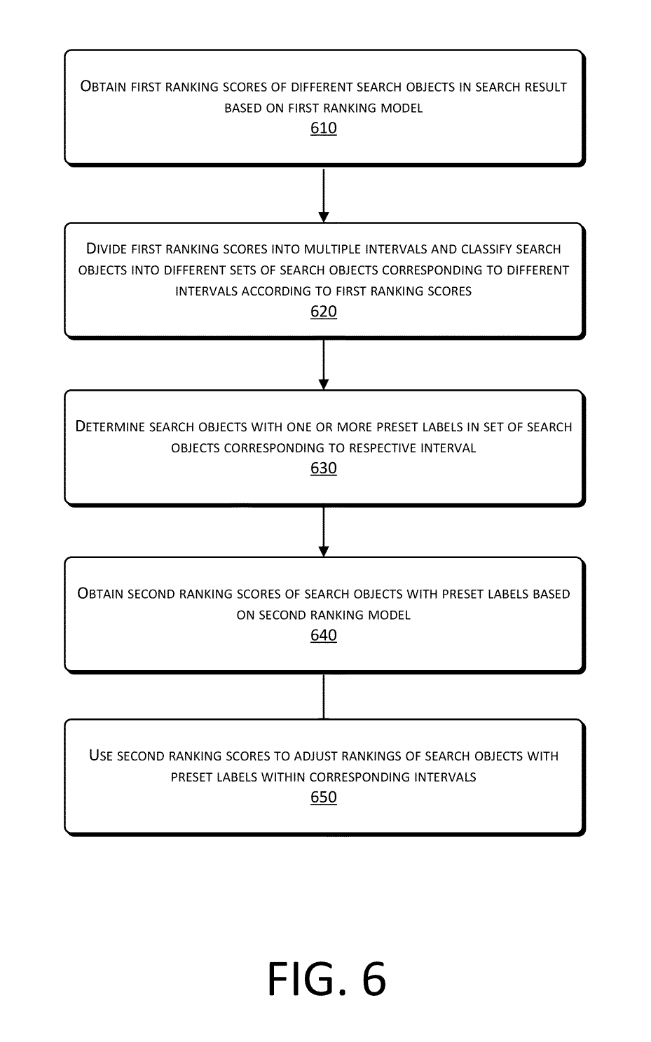

FIG. 6 illustrates a flowchart of an example method for ranking search objects according to an example embodiment of data search processing method, in which the search objects are ranked and re-adjusted in rankings.

At 610, first ranking scores of different search objects in the search result are obtained based on a first ranking model.

The first ranking model is used to find data objects through the calculation of the similarity degree by the indexing model according to the keyword segmented by inquiry terms input by the user during the process of matching documents. The calculation of the similarity degree is to find a correlation between the keyword and the data object, i.e., a calculation of correlation. For example, the numbers or values of the correlations of the data objects are used as ranking scores according to the calculation of the similarity degrees. For another example, the ranking scores of the data objects may be determined according to a linear combined calculation of the correlation of the data objects derived from the calculation of the similarity degree and various other factors. Furthermore, a mathematical model for determining a rank of each data object is determined based on its ranking score. In other words, a search ranking logic is used to search data objects and rank the search result (including all searched data objects).

A respective ranking score of a respective search object in the search result obtained through a ranking calculation of the first ranking model is referred to as the first ranking score. The first ranking model may use a model such as a language model, a probability model, a Boolean model, a machine learning model, etc. to calculate the respective ranking score of the respective search object.

Following the previous product search example, for the purpose of brevity, only the correlation value/score obtained from the similarity degree calculation is used herein for illustration. The product search engine uses the search model to conduct search matching according to the inquiry term input by the user (which may be segmented into several keywords). For example, the Boolean model or the vector space model may be used to calculate the similarity degree between the inquiry term and the text description of each product to obtain the ranking scores of the search products A to I, i.e., the first ranking scores of the products in the search result based on the first ranking model.

At 620, the first ranking scores are divided into multiple intervals. The search objects are classified into different sets of search objects corresponding to different intervals according to the first ranking scores.

The first ranking scores are divided into multiple intervals, which may be set through presetting several correlation threshold values, such as scores 20, 10. For example, the first ranking scores are divided into a first interval in which scores are “higher than or equal to 20,” a second interval in which scores are “higher than or equal to 10 and less than 20,” and a third interval in which scores are “less than 10.” Thus, a threshold value is preset for each interval. The respective ranking score of the respective search object is compared with the threshold value to determine whether the respective ranking score falls into the interval. If the respective ranking score falls into the interval, the search object corresponding to the respective ranking score is classified into a set of search objects corresponding to the interval.

Using the previous product search example, within the products A to I, assuming that the preset threshold value is 20, the first ranking scores are divided into two intervals, e.g., a first interval in which the scores are higher than or equal to 20 and a second interval in which the scores are less than 20. The first ranking scores of the products G, H, and I are 19, 18, and 17 respectively. Thus, the set of products that is classified into the second interval is II={G, H, I}. H and I are advertised products with normal placement status. The first rankings scores of the products A, B, C, D, E, and F are higher than 20 and are from high to low. Thus, the set of products that is classified into the first interval is I={A, B, C, D, E, F}. C, E, and F are advertised products with normal placement status.

At 630, search objects with the preset label in the set of search objects corresponding to a respective interval are determined.

The set of search objects corresponding to each interval includes one or more search objects. Some search objects have the preset label. The preset label indicates that the search objects (or data objects) with the extension information and such extension information is valid or shows normal status.

Using the previous product search example, in the set of products I={A, B, C, D, E, F}, C, E, and F are advertised products with normal placement status. In the set of products II={G, H, I}, H and I are advertised products with normal placement status. The advertised products have the preset label that indicates that the products are associated with advertisements based on the products and the corresponding placement status is normal. For the purpose of brevity, using the set of products I as the example, the preset label is used to find the advertised products C, E, and F from the set of products I.

At 640, the second ranking scores of the search objects with the preset label are obtained based on the second ranking model.

For example, the ranking scores of the search objects with the preset label in a respective internal are calculated based on the second ranking model. The second ranking model may be a ranking logic. In addition, the second ranking model may be adjusted and designed according to actual needs. The description herein is just an example and shall not be construed to limit the present disclosure.

For example, each search object with the preset label includes the extension information (the extension information based on the data objects), corresponding various records, characteristic information, etc. Such various records and extension information are used to design the ranking rule or logic, i.e., the second ranking model. The second ranking scores are obtained based on the second ranking model. For example, the values of certain characteristic information or the values of the characteristic information that is used for calculation are determined to represent the rankings of the search objects. That is, such values are used as the second ranking scores. Such a method for determining values or calculating values is the second ranking model.

Within each interval, the search objects with the preset label may have the second ranking scores based on the second ranking model. The second ranking scores are adjusted ranking scores of the search objects.

Using the previous product search example, for example, the advertised products C, E, and F in the set of product I corresponding to the first interval are assigned to use click per pay (CPC) advertising mode to place the advertisement and for payment. The obtaining of the second ranking scores (including the bid of the advertiser, the calculation of ranking score, advertising fee deduction) from the second ranking model is illustrated as follows. The adjustment to the set of products II in the second interval is similar. For the purpose of brevity, the following description is based on the set of products I and an adjustment of ranking of the firstly ranked product.

For example, the advertiser is an owner of the advertised products, e.g., C, E, and F. The bid of the advertiser is a bid from the advertiser for the advertised product to be placed corresponding to an inquiry term/keyword. The bid is recorded. That is, the advertised product having a normal placement status in the set of searched products under 410 is marked and a corresponding advertisement, a bid for placement under the keyword, a collected advertisement quality score of the advertised product, etc. are also recorded. Table 1 shows an example bid of the advertiser for the advertised products. Table 2 shows the advertisement quality scores of the advertised products.

TABLE 1

| Product | Bid for Ranking Adjustment |
|---|---|
| C | 1 |
| E | 1.5 |
| F | 0.8 |

TABLE 2

| Product | Advertisement Quality Score |
|---|---|
| C | 60 |
| E | 50 |
| F | 30 |

An example designed ranking logic or ranking formula is: expected return (second ranking score)=bid*quality score. In addition, an example fee deduction logic or fee deduction logic is: actual fee deduction=bid of next ranking position*quality score of next ranking position/quality score+0.01. Then the second rankings/expected returns of the advertised products C, E, and F are 2, 1, and 3. The actual fee deduction of the advertised products C, E, and F are: 24/60+0.01=0.04, 60/50+0.01=1.21, 0.8 (fee deduction for the last ranking position is the actual bid). Table 3 shows the calculated second ranking scores and actual fee deductions.

TABLE 3

| | Second Ranking | | Actual Fee |
|---|---|---|---|
| Product | Score | Ranking | Deduction |
| C | 60 | 2 | 0.41 |
| E | 75 | 1 | 1.21 |
| F | 24 | 3 | 0.8 |

In addition, some other methods may be used for the bidding of the advertiser, the calculation of the second ranking score (to be adjusted by the search engine), and advertisement fee deduction, which should not affect the core concepts of the present disclosure. For example, cost per 1,000 impressions (CPM) advertising mode may be used to place advertisement and charge fee. In addition, the second ranking scores may be calculated according to the bid of the advertiser for 1,000 times of presentation.

At 650, the second ranking scores are used to adjust the rankings of the search objects with the preset label within their corresponding intervals.

Within the set of search objects corresponding to each interval, the search objects with the preset label may be assigned the second ranking scores according to the second ranking models according to certain rules based upon need. The rankings of the search objects with the preset label within the set of search objects corresponding to each interval are adjusted according to the second ranking scores.

For example, the respective second ranking score of the respective search object is its new ranking score and compared with ranking scores of the other search objects within the interval corresponding to the respective search object. If the respective second ranking score is the highest score, from high to low, the respective search object is adjusted to a top position within the set of search objects (the first position). For another example, the respective second ranking score of the respective search object is compared with ranking scores of the other search objects with the preset label within the interval corresponding to the respective search object. If the second ranking score of another respective search object is the highest ranking score, according to the rule that prioritizes the search object with the preset label and only the first position is adjusted, the other respective search object with the preset label is adjusted to the top position of the set of the search objects and the ranking scores of other search objects are ranked from high to low.

The adjustment of the first position is described as above. The adjustments of the second position, the third position, the fourth position, and so on in the rankings may be performed according to similar methods.

Using the previous product search example, within the set of products I corresponding to the first interval, the products A to F were previously ranked by ABCDEF. According to the previously calculated second ranking scores, among the advertised products C, E, and F, the second ranking score of the product E is 75, which is the highest. The second ranking score of the product C is 60. The second ranking score of the product F is 24, which is the lowest.

For example, if the advertised products are ranked in priority and only the first position is adjusted, the product E may be placed in the first position of the set of products I. The adjusted rankings of the products in the set of products I corresponding to the first interval are EABCDF.

For another example, if the advertisements are clicked and the fees for the advertisements are to be collected, the set of products in each interval, such as all of the advertised products C, E, and F in the set of products I corresponding to the first interval, is adjusted according to the second ranking scores of the products. For a first instance, if the advertised products have absolute priority, the final adjusted rankings are ECFABD according to the previously described second ranking scores. For a second instance, if the advertised products keep their rankings according to the first ranking scores, e.g., CEF, the products are ranked by reference to the second ranking scores. For instance, the rule is that the respective position of the respective product is moved upward at most ten percent with integral value. The advertised product E is moved upward at most 7 positions (75/10 is rounded). The advertised product C is moved upward at most 6 positions (60/10 is rounded). The advertised product F is moved upward at most 2 positions (24/10 is rounded). Thus, according to the original rankings ABCDEF, C is moved upward 6 positions, E is moved upward 7 positions, and F is moved upward 2 positions. The final rankings are adjusted to CEABFD. For a third instance, the first ranking scores and the second ranking scores are combined to adjust the final ranking scores. Assuming the final ranking scores of the products A, B, C, D, E, and F are 120, 100, 50, 40, 30, and 10 respectively, the second ranking scores are used to adjust the final ranking scores (such that the second ranking scores are combined with the first ranking scores) and the final ranking scores are 120, 100, 110, 40, 105, and 34 respectively. The final ranking positions are adjusted to ACEBDF.

At 430, the search result after ranking or the ranked search result is returned to the user.

The application server receives the ranked search result or the search result in which the adjustment of rankings are completed, renders the page displayed at the browser, and returns the search result to the browser. The search objects in the search result are displayed according to their rankings at the browser. In addition, with respect to the search objects with the preset label, the extension information of the search objects is also returned along with such search objects.

Using the previous product search example, within the set of products I corresponding to the first interval, the application server receives the ranked search result from the search engine, renders the page displayed at the browser, and returns the search result to the browser. The products A to F are displayed in a sequence or ranking of EABCDF at the browser. Furthermore, if the user is interested in the advertisement of the product E, the product is clicked and the advertiser deducts 1.21 according to Table 3.

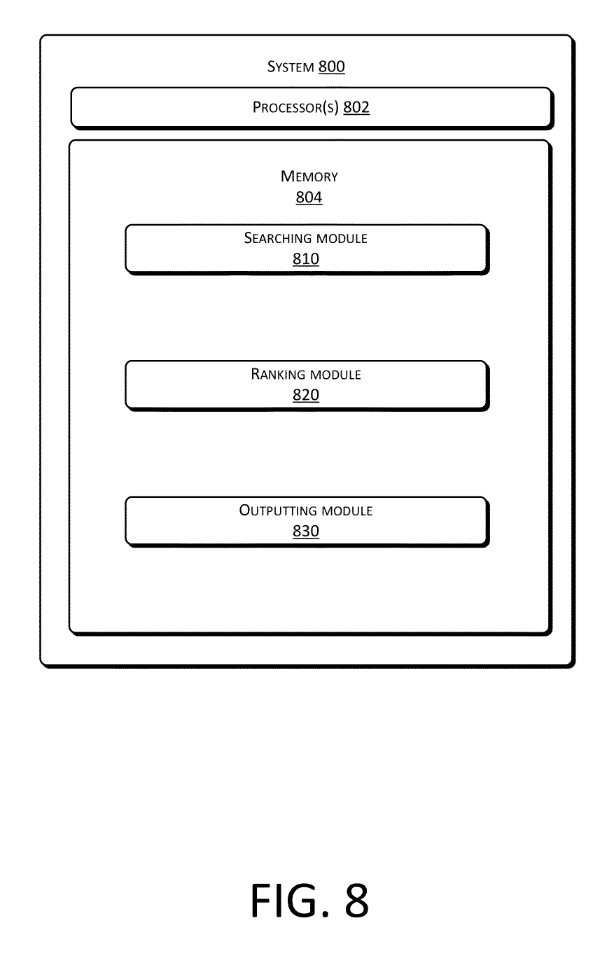

FIG. 8 illustrates a structural diagram of an example data search processing system 800 according to the present disclosure.

The system 800 may include one or more processor(s) or data processing unit(s) 802 and memory 804 and one or more input/output devices (not shown in FIG. 8). The memory 804 is an example of computer-readable media.

The memory 804 may store therein a plurality of modules or units including a searching module 810, a ranking module 820, and an outputting module 830. The searching module 810 obtains a search result according to a keyword input by a user. The detailed implemented functions of the searching module 810 may refer to processing at 410. The ranking module 820 ranks the various search objects in the obtained search result. The detailed implemented functions of the ranking module 820 may refer to processing at 420. The outputting module returns the ranked search result to the user. The detailed implemented functions of the outputting module may refer to processing at 430.

For example, the ranking module 820 may also include a first ranking score module, a classifying module, a determining module, a second ranking score module, and a ranking adjusting module (all of these modules are not shown in FIG. 8). The first ranking score module obtains first ranking scores of different search object in the search result based on a first ranking model. The classifying module divides the first ranking scores into multiple intervals and classifies the search objects into different sets of search objects corresponding to the multiple intervals. The determining module determines one or more search objects with a preset label within a set of data objects corresponding to each interval. The second ranking score module obtains second ranking scores of the search objects with the preset label based on a second ranking model. The ranking adjusting module uses the second ranking scores to adjust rankings of the search objects with the preset label within the sets of search objects of the corresponding intervals. The detailed implemented function may refer to processing at 650.

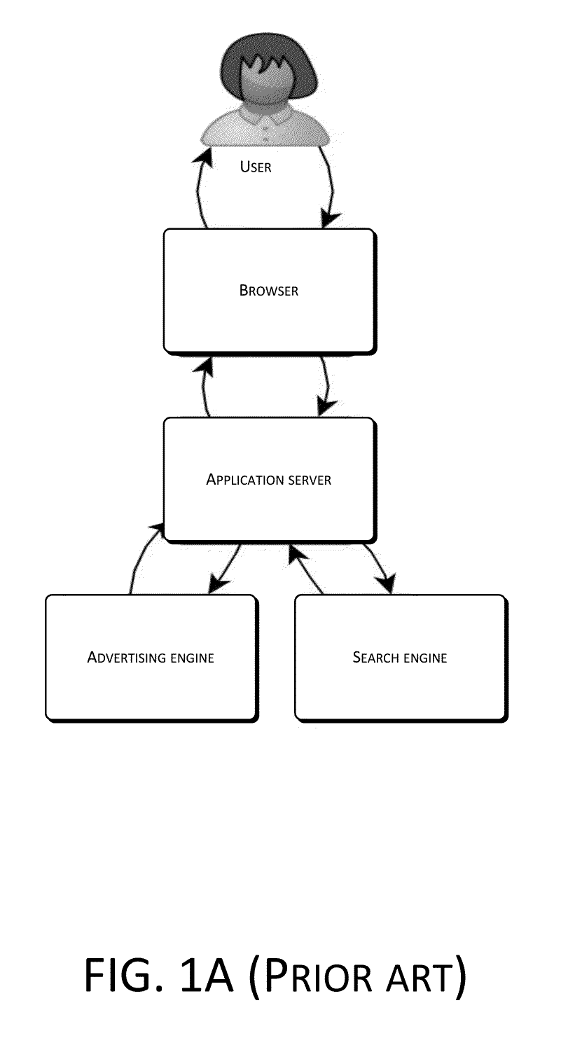

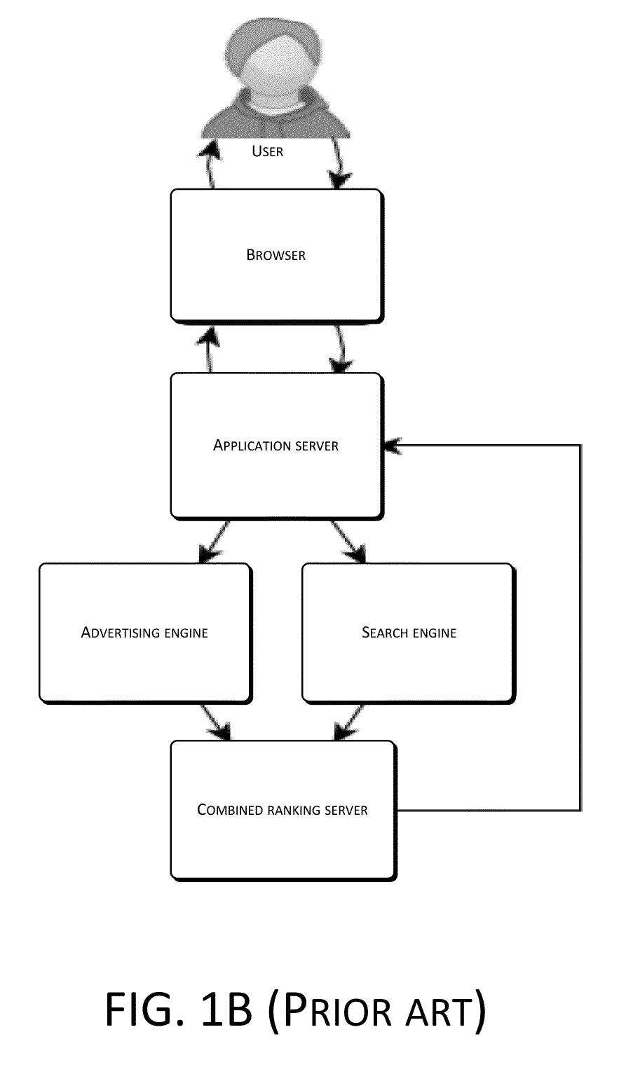

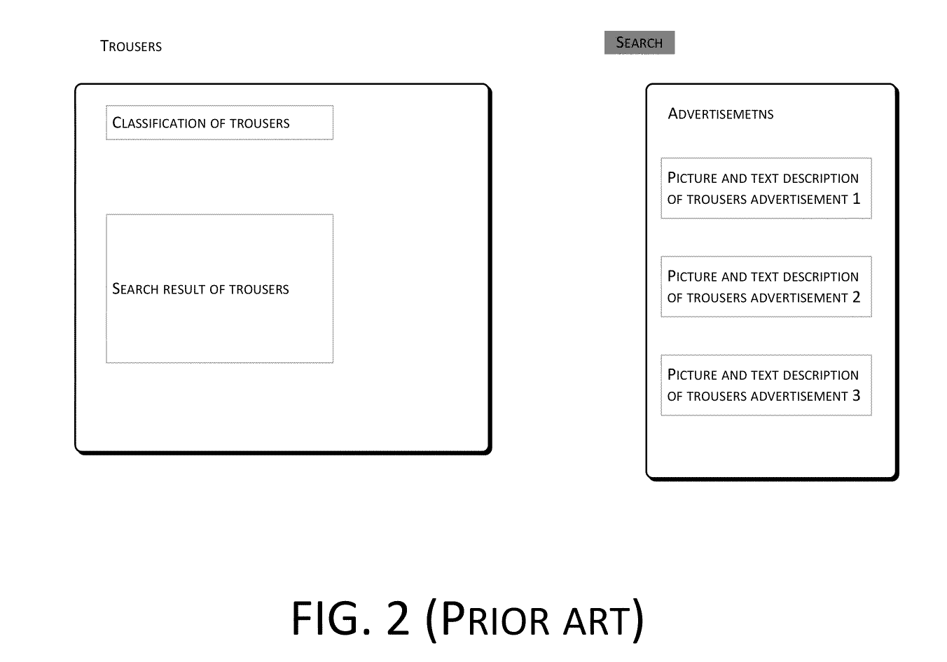

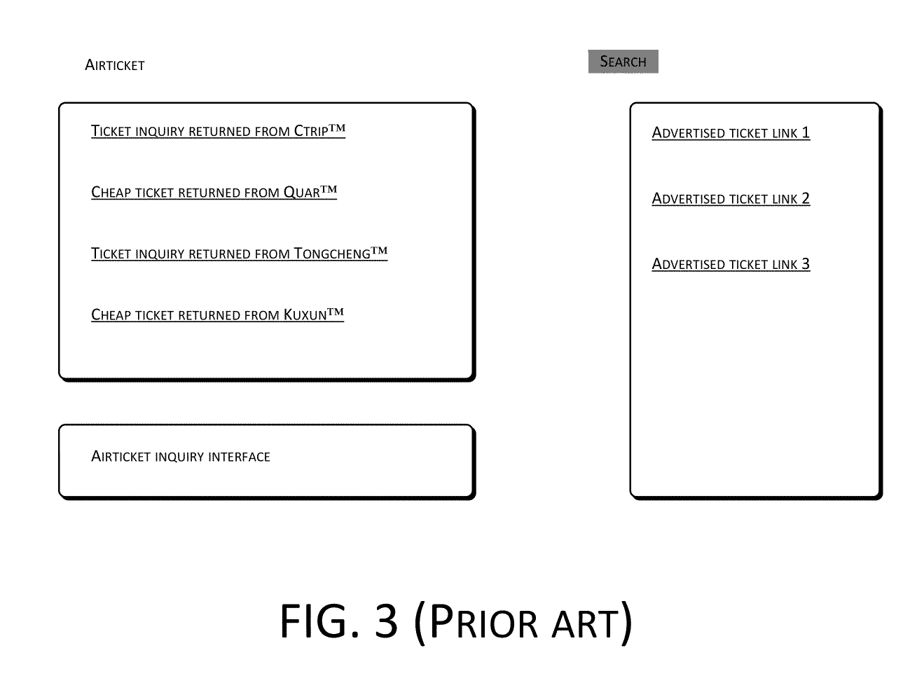

As the processing and functions implemented by the example system of the present disclosure are basically corresponding to the example method embodiments as shown in FIGS. 1-7, the details may refer to relevant portions in those example embodiments and are not described herein.

In a standard configuration, a computing device, such as the application server, the search engine, the advertising engine, the system, the device on which the browser is installed, as described in the present disclosure may include one or more central processing units (CPU), one or more input/output interfaces, one or more network interfaces, and memory.

The memory may include forms such as non-permanent memory, random access memory (RAM), and/or non-volatile memory such as read only memory (ROM) and flash random access memory (flash RAM) in the computer-readable media. The memory is an example of computer-readable media.

The computer-readable media includes permanent and non-permanent, movable and non-movable media that may use any methods or techniques to implement information storage. The information may be computer-readable instructions, data structure, software modules, or any data. The example of computer storage media may include, but is not limited to, phase-change memory (PCM), static random access memory (SRAM), dynamic random access memory (DRAM), other type RAM, ROM, electrically erasable programmable read only memory (EEPROM), flash memory, internal memory, CD-ROM, DVD, optical memory, magnetic tape, magnetic disk, any other magnetic storage device, or any other non-communication media that may store information accessible by the computing device. As defined herein, the computer-readable media does not include transitory media such as a modulated data signal and a carrier wave.

It should be noted that the term “including,” “comprising,” or any variation thereof refers to non-exclusive inclusion so that a process, method, product, or device that includes a plurality of elements does not only include the plurality of elements but also any other element that is not expressly listed, or any element that is essential or inherent for such process, method, product, or device. Without more restriction, the elements defined by the phrase “including a . . . ” does not exclude that the process, method, product, or device includes another same element in addition to the elements.

One of ordinary skill in the art would understand that the example embodiments may be presented in the form of a method, a system, or a computer software product. Thus, the present techniques may be implemented by hardware, computer software, or a combination thereof. In addition, the present techniques may be implemented as the computer software product that is in the form of one or more computer storage media (including, but is not limited to, disk, CD-ROM, or optical storage device) that include computer-executable or computer-readable instructions.

The above description describes the example embodiments of the present disclosure, which should not be used to limit the present disclosure. One of ordinary skill in the art may make any revisions or variations to the present techniques. Any change, equivalent replacement, or improvement without departing the spirit and scope of the present techniques shall still fall under the scope of the claims of the present disclosure.

What is claimed is:

1. A data search processing method comprising:
obtaining first ranking scores of multiple search objects within a search result based on a first ranking model;
dividing the first ranking scores into multiple intervals;
classifying one or more search objects of the multiple search objects into a respective set of search objects corresponding to a respective interval of the multiple intervals according to first ranking scores of the one or more search objects;
determining one or more search objects with one or more preset labels within the respective set of search objects;
obtaining second ranking scores of the one or more search objects with the one or more preset labels based on a second ranking model; and
using the second ranking scores to adjust rankings of the one or more search objects with the one or more preset labels within the respective set of search objects.

2. The method of claim 1, wherein the obtaining the first ranking scores of multiple search objects within the search result based on the first ranking model comprises:
obtaining the search result according to a keyword;
calculating a respective correlation value between a respective search object of the multiple search objects and the keyword based on the first ranking model; and
using the respective correlation value as a respective first ranking score of the respective search object.

3. The method of claim 1, wherein the dividing the first ranking scores into multiple intervals comprises:
setting one or more correlation threshold values; and
dividing the first ranking scores into the multiple intervals based on the one or more correlation threshold values.

4. The method of claim 1, wherein the classifying one or more search objects of the multiple search objects into the respective set of search objects corresponding to the respective interval according to first ranking scores of the one or more search objects comprises:
classifying a respective search object into the respective set of search objects corresponding to the respective interval according to a respective first ranking score of the respective search object.

5. The method of claim 1, wherein the one or more search objects with the one or more preset labels includes extension information of the one or more search objects with the one or more preset labels.

6. The method of claim 5, wherein the one or more search objects with the one or more preset labels comprise a record related to the extension information.

7. The method of claim 1, wherein the one or more preset labels indicate that a respective search object with a respective preset label includes extension information.

8. The method of claim 7, wherein the extension information includes an advertisement.

9. The method of claim 1, wherein the obtaining the second ranking scores of the one or more search objects with the one or more preset labels based on the second ranking model comprises:
using a respective record of a respective search object with a respective preset label to calculate a respective second ranking score of the respective search object with the respective preset label.

10. The method of claim 1, wherein the using the second ranking scores to adjust the rankings of the one or more search objects with the one or more preset labels within the respective set of search objects comprises:
using a respective second ranking score of a respective search object with a respective preset label to determine a new ranking of the respective search object with the respective preset label in the respective set of search objects.

11. A data search processing system comprising:
a first ranking score module that obtains first ranking scores of multiple search objects within a search result based on a first ranking model;
a classifying module that divides the first ranking scores into multiple intervals and classifies one or more search objects of the multiple search objects into a respective set of search objects corresponding to a respective interval of the multiple intervals according to first ranking scores of the one or more search objects;
a determining module that determines one or more search objects with one or more preset labels within the respective set of search objects;
a second ranking score module that obtains second ranking scores of the one or more search objects with the one or more preset labels based on a second ranking model; and
a ranking adjusting module that uses the second ranking scores to adjust rankings of the one or more search objects with the one or more preset labels within the respective set of search objects.

12. The system of claim 11, wherein the first ranking score module:
obtains the search result according to a keyword;
calculates a respective correlation value between a respective search object of the multiple search objects and the keyword based on the first ranking model; and
uses the respective correlation value as a respective first ranking score of the respective search object.

13. The system of claim 11, wherein the classifying module:
sets one or more correlation threshold values; and
divides the first ranking scores into the multiple intervals based on the one or more correlation threshold values.

14. The system of claim 11, wherein the classifying module classifies a respective search object into the respective set of search objects corresponding to the respective interval according to a respective first ranking score of the respective search object;

15. The system of claim 11, wherein the one or more search objects with the one or more preset labels includes extension information of the one or more search objects with the one or more preset labels.

16. The system of claim 15, wherein the one or more search objects with the one or more preset labels includes a record related to the extension information.

17. The system of claim 11, wherein the one or more preset labels indicate that a respective search object with a respective preset label includes extension information.

18. The system of claim 17, wherein the extension information includes an advertisement.

19. The system of claim 11, wherein:
the second ranking score module uses a respective record of a respective search object with a respective preset label to calculate a respective second ranking score of the respective search object with the respective preset label; and
the ranking adjusting module uses the respective second ranking score of the respective search object with the respective preset label to determine a new ranking of the respective search object with the respective preset label in the respective set of search objects.

20. One or more memories having stored thereon computer-executable instructions executable by one or more processors to perform operations comprising:
obtaining first ranking scores of multiple search objects within a search result based on a first ranking model;
dividing the first ranking scores into multiple intervals;
classifying one or more search objects of the multiple search objects into a respective set of search objects corresponding to a respective interval according to first ranking scores of the one or more search objects;
determining one or more search objects with one or more preset labels within the respective set of search objects;
obtaining second ranking scores of the one or more search objects with the one or more preset labels based on a second ranking model; and
using the second ranking scores to adjust rankings of the one or more search objects with the one or more preset labels within the respective set of search objects.
